(19) United States
(12) Patent Application Publication
(10) Pub. No.: US 2025/0220554 A1
(43) Pub. Date: Jul. 3, 2025

(54) APPARATUS AND METHOD FOR ENHANCING SATELLITE COMMUNICATION

(71) Applicant: Samsung Electronics Co., Ltd., Suwon-si, Gyeonggi-do (KR)

(72) Inventors: Lalith KUMAR, Bengaluru (IN); Chadi KHIRALLAH, Chertsey (GB); Mahmoud WATFA, Chertsey (GB)

(21) Appl. No.: 18/850,391

(22) PCT Filed: Mar. 30, 2023
(86) PCT No.: PCT/KR2023/004297

§ 371 Date: Sep. 24, 2024

(30) Foreign Application Priority Data
Mar. 30, 2022 (IN) 202231018622
Mar. 23, 2023 (GB) 2304263.3

(51) Int. Cl. H04W 48/08; H04W 84/06

(52) U.S. Cl. CPC H04W 48/08; H04W 84/06

(57) ABSTRACT

The disclosure relates to a 5G or 6G communication system for supporting a higher data transmission rate. According to an embodiment, the method comprises identifying one or more parameters associated with discontinuous coverage: determining, based on the one or more parameters associated with discontinuous coverage, a user equipment (UE) out-of-coverage period; and in case of determining the UE-out-of-coverage period, transmitting to the UE a signal including an extended connected time parameter, wherein the UE is maintained in a connected mode for the extended connected time parameter.

### TECHNICAL FIELD

The present disclosure relates to enhancements for 5G satellite architecture for accounting for discontinuous coverage that may result from satellite communications.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), Al service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

It is an aim of certain examples of the present disclosure to address the impacts of discontinuous coverage that result from satellite communications when determining communications behaviours of 5G systems and the UEs thereof.

According to a first aspect of the present disclosure there is provided a method for operating a 3GPP mobile communications system including a core network and a user equipment (UE), wherein the UE is configured to communicate with the core network via a satellite communication link, the method comprising identifying one or more discontinuous coverage parameters of the satellite communication link with the UE; and determining one or more communication parameters of the UE for communicating via the satellite communication link based on the discontinuous coverage parameters.

In an example of the present disclosure the one or more discontinuous coverage parameters of the satellite communication link includes a satellite fly-over time and a remaining time before the satellite flyover a time commences.

In an example of the present disclosure the one or more communication parameters of the UE includes an active time value for a Mobile Initiated Connection Only (MICO) or Power Savings Mode (PSM) mode; an estimated maximum wait time; and a time for the UE to be in a connected mode.

In an example of the present disclosure determining an active time value for a Mobile Initiated Connection Only (MICO) or Power Savings Mode (PSM) mode includes determining the active time value to be less than or equal to the satellite flyover time, and positioning the active time within the satellite flyover time.

In an example of the present disclosure determining an estimated maximum wait time includes determining the estimated maximum wait time based on an expected time until a next satellite flyover commences.

In an example of the present disclosure determining a time for the UE to be in a connected mode includes one or more of determining the time for the UE to be in a connected mode based on a satellite flyover time or a remaining satellite flyover time; determining the time for the UE to be in a connected mode based on a subscription parameter of the UE; determining the time for the UE to be in a connected mode based on a request received from the UE; determining the time for the UE to be in a connected mode based a volume of data to be transmitted or received by the UE; and determining the time for the UE to be in a connected mode based on a battery level of the UE.

According to a second aspect of the present disclosure there is provided a 3GPP mobile communications system configured to implement any of the preceding aspects or examples.

According to another aspect of the present disclosure there is provided a computer readable storage medium having stored thereon computer executable instructions which when executed by a 3GPP mobile communications system cause the 3GPP mobile communications system to perform the method of any perform any of the above aspects and examples.

### BRIEF DESCRIPTION OF DRAWINGS

FIG. 1 illustrates a block diagram of a network entity in accordance with an embodiment of the present disclosure.

FIG. 2 illustrates a block diagram of a user equipment (UE) in accordance with an embodiment of the present disclosure.

FIG. 3 illustrates a flow chart of a method for enhancing satellite communication in accordance with an embodiment of the present disclosure.

FIG. 4 illustrates a flow chart of a method for enhancing satellite communication in accordance with an embodiment of the present disclosure.

### BEST MODE FOR CARRYING OUT THE INVENTION

In one embodiment, a method performed by an access and mobility management function (AMF) in a wireless communication system is provided. The method includes identifying one or more parameters associated with discontinuous coverage; determining, based on the one or more parameters associated with discontinuous coverage, a user equipment (UE) out-of-coverage period; and in case of determining the UE-out-of-coverage period, transmitting to the UE a signal including an extended connected time parameter, wherein the UE is maintained in a connected mode for the extended connected time parameter.

The method performed by the AMF, wherein the UE-out-of-coverage period comprises a period in which there is a lack of availability of satellite coverage for the UE.

The method performed by the AMF, wherein the one or more parameters associated with discontinuous coverage includes at least one of: a satellite fly-over time or a remaining time before the satellite flyover a time commences.

The method performed by the AMF, further comprising: providing the extended connected time parameter to a Radio Access Network (RAN) via higher layer signalling.

The method performed by the AMF, wherein the UE is maintained in an N2 connection for the extended connected time parameter.

In one embodiment, a method performed by a user equipment (UE) in a wireless communication system is provided. The method includes, in case of determining an UE-out-of-coverage period, receiving, from an access and mobility management function (AMF), a signal including an extended connected time parameter, wherein one or more parameters associated with discontinuous coverage are identified, and wherein based on the one or more parameters associated with discontinuous coverage, the UE-out-of-coverage period is determined; and maintaining in connected mode for the extended connected time parameter.

The method perform by the UE, wherein the UE-out-of-coverage period comprises a period in which there is a lack of availability of satellite coverage for the UE.

The method perform by the UE, wherein the one or more parameters associated with discontinuous coverage includes at least one of: a satellite fly-over time or a remaining time before the satellite flyover a time commences.

The method perform by the UE, wherein the receiving the signal including the extended connected time parameter comprises receiving the signal from a Radio Access Network (RAN) via high layer signalling.

The method perform by the UE, wherein maintaining in connected mode comprises maintaining an N2 connection.

In one embodiment, an access and mobility management function (AMF) in a wireless communication system for enhancing a satellite communication is provided. The AMF includes a transceiver; and at least one processor coupled with the transceiver and at least one processor configured to: identify one or more parameters associated with discontinuous coverage; determine, based on the one or more parameters associated with discontinuous coverage, a user equipment (UE) out-of-coverage period; and in case of determining the UE-out-of-coverage period, transmit to the UE a signal including an extended connected time parameter, wherein the UE is maintained in a connected mode for the extended connected time parameter.

The AMF according to an embodiment, wherein the UE-out-of-coverage period comprises a period in which there is a lack of availability of satellite coverage for the UE.

The AMF according to an embodiment, wherein the one or more parameters associated with discontinuous coverage includes at least one of: a satellite fly-over time or a remaining time before the satellite flyover a time commences.

The AMF according to an embodiment, the at least one processor further configured to: provide the extended connected time parameter to a Radio Access Network (RAN) via higher layer signalling.

In one embodiment, a user equipment (UE) in a wireless communication system for enhancing a satellite communication is provided. The UE includes a transceiver; and at least one processor coupled with the transceiver and comprised to: in case of determining an UE-out-of-coverage period, receive, from an access and mobility management function (AMF), a signal including an extended connected time parameter, wherein one or more parameters associated with discontinuous coverage are identified, and wherein based on the one or more parameters associated with discontinuous coverage, the UE-out-of-coverage period is determined; and maintain in connected mode for the extended connected time parameter.

### MODE FOR THE INVENTION

Wireless or mobile (cellular) communications networks in which a mobile terminal (UE, such as a mobile handset) communicates via a radio link with a network of base stations, or other wireless access points or nodes, have undergone rapid development through a number of generations. The 3^{rd} Generation Partnership Project (3GPP) design, specify and standardise technologies for mobile wireless communication networks. Fourth Generation (4G) systems are now widely deployed.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the EUTRAN, and LTE is used in this sense in the remainder of this document. LTE should also be taken to include LTE enhancements such as LTE Advanced and LTE Pro, which offer enhanced data rates compared to LTE.

The trend towards greater data throughput continues with the standardisation and deployment of Fifth Generation (5G) systems. As part of this, a new air interface is being developed, which may be referred to as 5G New Radio (5G NR) or simply NR. NR is designed to support the wide variety of services and use case scenarios envisaged for 5G networks, though builds upon established LTE technologies.

New frameworks and architectures are also being developed as part of 5G networks in order to increase the range of functionality and use cases available through 5G networks. One such new architecture focusses on the use of satellite access for 5G systems. Satellite access can often include discontinuous coverage; however, a number of current approaches to determining communication behaviours by 5G systems and the UEs thereof do not take account of such discontinuous coverage, thus leading to problems such as degraded communication performance and increased power consumption at UEs for example.

Throughout the disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. Hereinafter, operation principles of the disclosure will be described in detail with reference to accompanying drawings. In the following descriptions, well-known functions or configurations are not described in detail because they would obscure the disclosure with unnecessary details. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in correspondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the disclosure is defined by the appended claims. Throughout the specification, like reference numerals refer to like elements. It will be understood that blocks in flowcharts or combinations of the flowcharts may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be formed so as to be in an addressable storage medium, or may be formed so as to operate one or more processors. Thus, for example, the term “unit” may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and “units” may be combined into the smaller number of elements and “units”, or may be divided into additional elements and “units”. Furthermore, the elements and “units” may be embodied to reproduce one or more central processing units (CPUs) in a device or security multimedia card. Also, in an embodiment of the disclosure, the “unit” may include at least one processor. In the following descriptions of the disclosure, well-known functions or configurations are not described in detail because they would obscure the disclosure with unnecessary details.

Hereinafter, for convenience of explanation, the disclosure uses terms and names defined in the 3rd generation partnership project long term evolution (3GPP LTE) standards. However, the disclosure is not limited to the terms and names, and may also be applied to systems following other standards.

In the disclosure, an evolved node B (eNB) may be interchangeably used with a next-generation node B (gNB) for convenience of explanation. That is, a base station (BS) described by an eNB may represent a gNB. In the following descriptions, the term “base station” refers to an entity for allocating resources to a user equipment (UE) and may be used interchangeably with at least one of a gNode B, an eNode B, a node B, a base station (BS), a radio access unit, a base station controller (BSC), or a node over a network. The term “terminal” may be used interchangeably with a user equipment (UE), a mobile station (MS), a cellular phone, a smartphone, a computer, or a multimedia system capable of performing communication functions. However, the disclosure is not limited to the aforementioned examples. In particular, the disclosure is applicable to 3GPP new radio (NR) (or 5th generation (5G)) mobile communication standards. In the following description, the term eNB may be interchangeably used with the term gNB for convenience of explanation. That is, a base station explained as an eNB may also indicate a gNB. The term UE may also indicate a mobile phone, NB-IoT devices, sensors, and other wireless communication devices.

Examples in accordance with the present disclosure will now be described in the context of a 5G wireless communication network. However, it will be understood that the present disclosure is not limited to only 5G system but may be applied to other wireless communication systems in which satellite communications are available. Consequently, references to particular 3GPP constructs in certain examples should not be understood as limiting the ability of examples of the present disclosure to be applied to other wireless communication networks.

3GPP is developing solutions for the use of satellite access for connecting Internet of Things (IoT) devices to the core network such as Evolved packet Core (EPC). The related work item can be found in 3GPP TS 23.501 v17.4.0 23/03/2022.

One of the aspects that is listed in this work item 3GPP TS 23.501 v17.4.0 23/03/2022 relates to discontinuous coverage (DC) which is that a satellite's coverage is not always available for the UE, and hence it is discontinuous. The lack of availability is due to the satellite going around the planet such that a certain time is required for a full circle to be made after which the coverage comes again. In the presence of the satellite, and hence coverage, the concept of fly-over time is discussed which is basically the duration of time for which coverage is available. As an example, a satellite may take 10 hrs to go around the planet at a certain orbit or distance such that the UE on earth can only detect coverage after 10 hrs. Moreover, the coverage may only last for 2 mins (as an example). Examples of flyover times and coverage times can be found in 3GPP TS 23.502 v17.4.0 23/03/2022.

Additionally, when using satellite communication, the UE will not be able to send any message if it does not obtain its location or position. The time needed to do so is referred to Time To First Fix (TTFF). The duration of TTFF depends on the state of the receive which may be one of three: cold, warm, or hot. In 3GPP TS 24.501 v17.6.1 26/03/2022, 3GPP RAN2 working group has assumed certain example values such that from a cold state, the GNSS fix can take up to 100s, from a warm state—50s and from hot start—2s.

A number of problems resulting from the use of satellite communications for have been identified, a number of which are set out below.

No consideration of discontinuous coverage for setting of an active timer which is used for power savings mode feature

MICO (Mobile Initiated Connection Only) mode is defined in TS 23.501 and TS 23.502, etc. MICO mode may involve the determination of an active time value for the UE which governs the time during which the UE monitors for paging after entering idle mode. If the determination of this timer does not consider discontinuous coverage, then the UE may end up monitoring paging or scanning for signals from a satellite that actually does not even provide coverage at the moment. This will drain the UE's power/battery.

The present disclosure is provide methods for determination of the Estimated maximum wait time does not consider discontinuous coverage.

Buffering of UE data when the UE is not reachable due to power savings is also described in TS 23.501, TS 23.502 and other documents. One aspect of buffering this data is to determine the Estimated maximum wait time which basically determines the duration of the time to buffer UE data, and after which these packets or data will be discarded. The AMF currently provides this information to the SMF e.g. as described below from TS 23.502:

“If the UE is in MICO mode, the AMF determines the Estimated Maximum Wait time based on the next expected periodic registration by the UE or by implementation. If the UE is using extended idle mode DRX, the AMF determines the Estimated Maximum Wait time based on the start of the next Paging Time Window. The AMF stores an indication that the SMF has been informed that the UE is unreachable.”

However, basing the buffer time on the periodic registration of the UE would not work in the case of satellite access with DC since it is the DC that actually impacts (or determines) the UE's reachability. Therefore the current method to determine the buffer time should be updated.

Low flyover time values will risk success of service and lower quality of experience.

The following is specified in TS 23.501 about the use of extended connected time for UEs that use MICO mode:

“When a UE, using MICO mode, initiates MO signalling or MO data and the AMF is aware of pending or expected MT traffic, the AMF may keep the UE in CM-CONNECTED state and the RAN may keep the UE in RRC-CONNECTED state for an Extended Connected Time period in order to ensure the downlink data and/or signalling is delivered to the UE. The Extended Connected Time is determined by the AMF and is based on local configuration and/or the Maximum Response Time, if provided by the UDM.

The AMF maintains the N2 connection for at least the Extended Connected Time and provides the Extended Connected Time value to the RAN. The Extended Connected Time value indicates the minimum time the RAN should keep the UE in RRC-CONNECTED state regardless of inactivity. The Extended Connected Time value is provided to the RAN together with the
NAS Registration Accept message; or
NAS Service Accept message.

At inter-RAN node handovers, if some signalling or data are still pending, the target AMF may send the Extended Connected Time value to the target RAN node.”

The above is done for UEs that use MICO and for which terminated data is expected. However, for UEs that use satellite but don't use MICO, the UEs will suffer from insufficient time for actual data communication if the flyover time is short and the UEs need to transition to connected mode more than once within the flyover time. For example, if the flyover time is 1 min and the UEs need to send data at different instances within this 1 min, then the UE will need to transition to connected mode a second time if after the first time it had gone back to idle mode.

However, this multiple transition from idle to connected mode will take time, generate signalling and also consume power. As such, it may not be efficient to put the UE back to idle mode at least when the flyover time is short.

The following proposals provide solutions to or at least mitigate the above-identified problems. Note that although the solutions are presented with EPS (i.e. S1 mode) as an example, the solutions would apply equally to 5GS (i.e. N1 mode) using similar NAS substrates, procedures, messages, or any equivalent of these. As such, the proposals should not be seen as limitations or as only applicable to EPS.

Note that the proposals herein can be applied by a UE when the UE is using satellite access, or a particular type of satellite access e.g. LEO, GEO, MEO, or any combination.

Alternatively, the UE behaves according to the current methods defined in TS 24.301 (or TS 24.501) when the UE is using the 3GPP access (or non-3GPP access). As such, based on the lower layers being used, the UE behaves differently; where in a particular, the UE behaves in accordance with the proposals herein when the satellite communication (or non-terrestrial networks-NTN) is being used as the lower layer access type. As such, if the UE determines that the access technology is satellite, then the UE may behave as defined herein. Otherwise the UE may behave as defined in TS 24.301 (or TS 24.501) i.e. without necessarily using the proposals herein.

Note that the proposals herein can be applied in any order and in any combination.

The present disclosure is provide methods for determining the active time value for MICO should consider the UE's satellite access and/or discontinuous coverage.

It is proposed that the network (UDM or AMF, or other similar nodes in EPS such as HSS or MME) should consider the use of satellite access or the flyover timer when determining the parameters for power saving features such as Power Savings Mode (PSM) or MICO (Mobile Initiated Connection Only) mode. Although MICO mode will be used herein, this should be considered to be an example and not a limitation. As such all the proposals for MICO mode can also apply to PSM.

When determining the active time value for MICO mode, the network may consider the flyover time of the satellite in use and the active timer value should not be greater than (i.e. less than or equal to) the flyover time. This is because the UE is anyway not reachable after the flyover time and keeping the active time value larger than the flyover time would mean that the UE will keep its lower layer functions (e.g. transmission or reception functions) active during the active time duration as the UE monitors for paging. This will lead to unnecessary power consumption/waste in the UE.

Therefore, the network should assign an active time value for MICO such that the value assigned is not larger than the flyover time of the satellite. In other words, the active time value should be determined/set to be within the time that the satellite is expected to actually provide coverage to the UE in question.

In one embodiment, if the UDM receives a request to use a particular active time value from an application function, optionally via the network exposure function (NEF), then the UDM should set the value of the active time value based on the proposal above i.e. by considering the access type of the UE and the flyover time if applicable.

As such, when the UE is being served by satellite access where the satellite access provides discontinuous coverage, then the determination of the active time value for MICO should be as described above. Otherwise, if the UE is not using satellite access, or if the UE is using satellite access but the satellite does not provide discontinuous coverage, then the network does not determine the active time value for MICO as proposed above but rather uses local configuration and/or based on the subscribed value (which does not assume satellite access, or at least satellite access with discontinuous coverage).

The present disclosure is provide methods for estimated maximum wait time should be determined by also taking into account satellite access/discontinuous reception.

As indicated earlier, the determination of the time to buffer (e.g. the determination of the Estimated maximum wait time) is currently based on the periodic registration timer. However, this determination should be updated to consider the use of satellite access or discontinuous coverage or flyover time.

When the AMF wants to determine the value of the Estimated maximum wait time, the AMF should consider the access type of the UE, e.g. by considering whether or not the UE is using satellite access or whether the satellite access provides discontinuous coverage (DC) or the duration of the flyover time (or any combination of these).

As such, if the UE in question is using satellite access and/or DC, then the AMF should determine the value of the Estimated maximum wait time based on the length of the DC or the remaining time until the satellite is available again. For this purpose, the AMF should maintain a timer, or at least track the time, for which the satellite is unavailable or for the duration of the lack of availability of satellite coverage or for the remaining duration of the DC. When providing the Estimated maximum wait time to the SMF, the AMF should indicate a value that does not exceed the remaining time of the DC or that does not exceed the remaining time after which the satellite is expected to provide coverage to the UE in question. Note that the AMF may determine the value of the Estimated maximum wait time based on a new subscription information that is defined in the UDM, where the value of this time is also based on the use of satellite access by the UE for which the DC and/or flyover time is known, or based on a predefined value for the Estimated maximum wait time considering the use of satellite access with DC.

Note that the AMF may determine the value of the Estimated maximum wait time based on the periodic registration timer of the UE if the latter is determined based on the use of satellite access optionally with DC and/or the duration of the flyover time.

Determining a timer value based on DC can mean that the entity which makes the determination (e.g. the AMF) would consider at least the length of the DC or the remaining time of the DC after which the satellite is expected to provide coverage (at least for a UE in question and/or for a known location such as a country, geographical area, list of tracking area identity, etc).

Additionally, the AMF may also indicate the expected flyover time so that the SMF is aware of the duration that represents the time window during which any buffered packets can be sent to the UE. Note that this indication may be provided regardless of the Estimated maximum wait time. For example, during the establishment of a new PDU session, the AMF may always provide this information to the SMF when forwarding the 5GSM message from a UE to the SMF. Optionally, this information is provided to the SMF by the UDM e.g. as part of session management subscription information. The SMF may store this information and use it to determine how much time is available to send data to the UE when the UE is available, where the SMF may determine using any existing method that the UE is now available (e.g. after the satellite starts its flyover time). The AMF may provide this information using any of the existing messages that are defined between the AMF and the SMF.

The present disclosure is provide methods for keeping UEs in connected mode for a longer time.

To ensure that the UEs get service during the flyover time, it is proposed that the network should keep the UEs in connected mode for a longer period of time. To achieve this, the following proposals are made where they can be used in any combination or order.

It is proposed to define a new subscription parameter which indicates if a UE in question should be kept in connected mode for an extended period of time when using satellite access optionally with DC. The extended period of time may be fixed or predefined or dependent on the satellite operational parameters e.g. based on the flyover time for each satellite. The subscription information that is being proposed may be a simple indication for keeping the UE in connected mode for an extended period, or may be (possibly/optionally in addition to the indication) the actual time for keeping the UE in connected mode. It is proposed that this new information be provided to the network by the UDM using the appropriate message between these nodes.

The AMF may determine, e.g. based on local configuration or subscription parameters, that a UE should be kept in connected mode for an extended period of time e.g. based on the use of satellite access optionally with DC. The actual duration of the UE being in connected mode may be determined by the AMF based on local policy or based on subscription information (optionally received from the UDM) or based on the flyover time that the satellite expects to operate with (where this information is expected to be known at the AMF).

The AMF may also determine that a UE in question should be kept in connected mode for an extended period of time if the UE indicates so e.g. by means of a capability or other new indication in the NAS layer. As such, it is proposed that the UE may request the network to keep it in connected mode for a longer period of time, where this indication may be sent by the UE based on local knowledge at the UE about the need to send data packets e.g. based on a request from the upper layers in the UE. As such, the UE may not always request to be kept in connected mode for a longer time. For example, if the UE determines that there is need to send data (e.g. for a longer time or based on the data size/volume available to be sent, etc), then the UE may request an extended period in connected mode, where this indication may be sent using any NAS message and using any new or existing information element. For example, the UE may send this indication in the registration request message (in N1 mode) or the tracking area update request message (in S1 mode), service request message or control plane service request message. However, the next time the UE needs to come to connected mode, the UE should re-evaluate if it needs to remain in connected mode for an extended period of time, where this evaluation may be based as explained above i.e. on the amount of data that is available for transmission (optionally from the upper layers), or where this evaluation may be based on the battery life of the UE (e.g. if the battery is lower than a certain threshold then the UE does not request extended connection, or if the battery is higher than the certain threshold then the UE may request an extended connection), or may be based on other local policy in the UE.

The AMF determines if the UE needs to be kept in connected mode as described above, using any combination of methods e.g. based on local AMF information and/or UE indication. The AMF may also make this determination based on any expected terminated data or based on an indication from any other core network node e.g. the PCF, the NEF Network Exposure Function), etc, where any such core network node may receive this request from an application function that uses network exposure services (e.g. via the NEF) to request an extended connected mode for the UE. Based on the determination to keep the UE in connected mode, and optionally based on the AMF determining the actual duration of extended connected mode for the UE (e.g. based on the flyover time of the satellite, where the time to extended the connection of the UE should not be larger than the flyover time), then the AMF should indicate to the RAN that the UE should be kept in connected mode for a longer period of time, optionally where the AMF may also indicate the actual duration for extending the UE's connection (or for keeping the UE in connected mode) e.g. the duration should be set to the value of the flyover time (or the remaining value of the flyover time).

The RAN may receive a request from the AMF to keep a UE in connected mode for an extended time, or the RAN may determine to do so based on local policies. The RAN should then keep the UE in connected mode for a longer period where the period may be known in the RAN or may be received from another network node e.g. the AMF (as described above).

Certain examples of the present disclosure provide a method for operating a 3rd Generation Partnership Project (3GPP) mobile communications system including a core network and a User Equipment (UE), wherein the UE is configured to communicate with the core network via a satellite communication link, the method comprising: determining, by an Access and Mobility Management Function (AMF) entity of the system, a UE out-of-coverage period comprising a period in which there is a lack of availability of satellite coverage for the UE; determining, by the AMF entity, based on the out-of-coverage period, one or more communication parameters of the UE, including an extended connected time parameter for determining a time for the UE to be in a connected mode, for communicating via the satellite communication link; and maintaining the UE in connected mode for the extended connected time.

In certain examples, the method may further comprise providing, by the AMF entity, the extended connected time parameter to a Radio Access Network (RAN) entity of the system.

In certain examples, determining the UE out-of-coverage period may comprise identifying one or more discontinuous coverage parameters of the satellite communication link with the UE.

In certain examples, the one or more discontinuous coverage parameters of the satellite communication link may include a satellite fly-over time and/or a remaining time before the satellite flyover a time commences.

In certain examples, determining a time for the UE to be in a connected mode may include determining the time for the UE to be in a connected mode based on a satellite flyover time and/or a remaining satellite flyover time.

In certain examples, the one or more communication parameters of the UE may further include one or more of: an active time value for a Mobile Initiated Connection Only (MICO) or Power Savings Mode (PSM) mode; and an estimated maximum wait time.

In certain examples, determining an active time value for a MICO and/or PSM mode may include determining the active time value to be less than or equal to a satellite flyover time, and positioning the active time within the satellite flyover time.

In certain examples, the estimated maximum wait time may be determined based on an expected time until a next satellite flyover commences.

In certain examples, maintaining the UE in connected mode may comprise maintaining a connection (e.g. an N2 connection, where N2 is the interface between AMF and RAN).

Certain examples of the present disclosure provide a 3GPP mobile communications system configured to implement a method according to any example, embodiment, aspect and/or claim disclosed herein.

Certain examples of the present disclosure provide a computer readable storage medium having stored thereon computer executable instructions which when executed by a 3GPP mobile communications system (e.g. one or more computers, processors and/or controllers in the system) cause the 3GPP mobile communications system (e.g. the one or more computers, processors and/or controllers in the system) to perform a method according to any example, embodiment, aspect and/or claim disclosed herein.

The proposals above can be used in any combination and in any order. Moreover, although the proposals are made with 5GS as an example, the proposals can also apply to EPS for which satellite may be used and as such the proposals are not limited to a UE in 5GS only.

A UE which is arranged to operate in accordance with any of the examples of the present disclosure described above includes a transmitter arranged to transmit signals to one or more RANs, including but not limited to a satellite network and a 3GPP RAN such as 5G NR network; a receiver arranged to receive signals from one or more RANs and other UEs; and a controller arranged to control the transmitter and receiver and to perform processing in accordance with the above described methods. The transmitter, receiver, and controller may be separate elements, but any single element or plurality of elements which provide equivalent functionality may be used to implement the examples of the present disclosure described above.

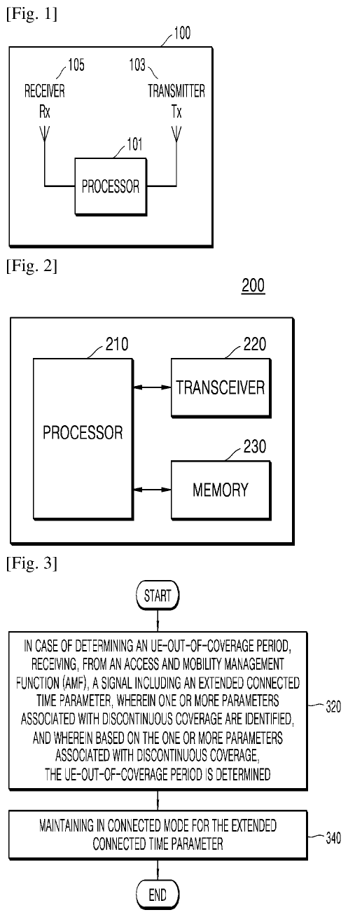

FIG. 1 is a block diagram of an exemplary network entity that may be used in examples of the present disclosure. For example, the UE, entities of the core network or RAN (e.g. eNB, gNB or satellite) may be provided in the form of the network entity illustrated in FIG. 1. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

The entity 100 comprises a processor (or controller) 101, a transmitter 103 and a receiver 105. The receiver 105 is configured for receiving one or more messages from one or more other network entities, for example as described above. The transmitter 103 is configured for transmitting one or more messages to one or more other network entities, for example as described above. The processor 101 is configured for performing one or more operations, for example according to the operations as described above. The transmitter 103 and the receiver 105 can be implemented as a transceiver.

FIG. 2 is a block diagram illustrating a UE 200 according to another embodiment of the present disclosure.

Referring to the FIG. 2, the UE 200 may include a processor 210, a transceiver 220 and a memory 230. However, all of the illustrated components are not essential. The UE 200 may be implemented by more or less components than those illustrated in FIG. 2. In addition, the processor 210 and the transceiver 220 and the memory 230 may be implemented as a single chip according to another embodiment.

The aforementioned components will now be described in detail.

The processor 210 may include one or more processors or other processing devices that control the proposed function, process, and/or method. Operation of the UE 200 aforementioned in this disclosure may be implemented by the processor 210.

The transceiver 220 may include a RF transmitter for up-converting and amplifying a transmitted signal, and a RF receiver for down-converting a frequency of a received signal. However, according to another embodiment, the transceiver 220 may be implemented by more or less components than those illustrated in components.

The transceiver 220 may be connected to the processor 210 and transmit and/or receive a signal. The signal may include control information and data. In addition, the transceiver 220 may receive the signal through a wireless channel and output the signal to the processor 210. The transceiver 220 may transmit a signal output from the processor 210 through the wireless channel.

The memory 230 may store the control information or the data included in a signal obtained by the UE 200. The memory 230 may be connected to the processor 210 and store at least one instruction or a protocol or a parameter for the proposed function, process, and/or method. The memory 230 may include read-only memory (ROM) and/or random access memory (RAM) and/or hard disk and/or CD-ROM and/or DVD and/or other storage devices.

FIG. 3 illustrates a flow chart of a method for enhancing satellite communication in accordance with an embodiment of the present disclosure. Referring to FIG. 3, a UE may operate as previously described in present disclosure.

In step 320, in case of determining an UE-out-of-coverage period, the UE may receive, from the AMF, a signal including an extended connected time parameter. The one or more parameters associated with discontinuous coverage are identified, and based on the one or more parameters associated with discontinuous coverage, the UE-out-of-coverage period is determined.

In step 340, The UE maintain in connected mode for the extended connected time parameter. The extended connected parameter is parameter for determining a time for the UE to be in the connected mode, for communicating via a satellite communication link, and is included in one or more communication parameters of the UE.

The one or more communication parameters of the UE is determined based on a UE out-of-coverage period. The UE out-of-coverage period comprises a period in which there is a lack of availability of satellite coverage for the UE. The UE out-of-coverage period is determined based on the one or more parameters associated with discontinuous coverage. The one or more parameters associated with discontinuous coverage are identified by the AMF, and may include at least one of the flyover time or remaining time before the satellite flyover a time commences.

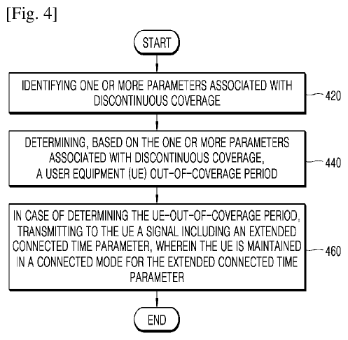

FIG. 4 illustrates a flow chart of a method for enhancing satellite communication in accordance with an embodiment of the present disclosure. Referring to FIG. 4, the AMF may operate as previously described in present disclosure.

In step 420, the AMF may identify the one or more parameters associated with discontinuous coverage. The one or more parameters associated with discontinuous coverage may include at least one of the flyover time or remaining time before the satellite flyover a time commences.

In step 440, the AMF determine the UE out-of-coverage period, based on the one or more parameters associated with discontinuous coverage.

In step 460, the AMF transmit to the UE an extended connected time parameter, in case of determining the UE-out-of-coverage period. The UE is maintained in connected mode for the extended connected time parameter.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

A particular network entity may be implemented as a network element on a dedicated hardware, as a software instance running on a dedicated hardware, and/or as a virtualised function instantiated on an appropriate platform, e.g. on a cloud infrastructure.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

Embodiments of the disclosure can also be embodied as a storage medium including instructions executable by a computer such as a program module executed by the computer. A computer readable medium can be any available medium which can be accessed by the computer and includes all volatile/non-volatile and removable/non-removable media.

Further, the computer readable medium may include all computer storage and communication media. The computer storage medium includes all volatile/non-volatile and removable/non-removable media embodied by a certain method or technology for storing information such as computer readable instruction code, a data structure, a program module or other data. Communication media may typically include computer readable instructions, data structures, or other data in a modulated data signal, such as program modules. In addition, computer-readable storage media may be provided in the form of non-transitory storage media.

The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to an embodiment of the disclosure, a method according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the present disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. Examples of the present disclosure extend to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The above embodiments are to be understood as illustrative examples of the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be used without departing from the scope of the invention, which is defined in any accompanying claims.

Further examples in accordance with the present disclosure are set out in the following embodiments.

In an embodiment, a method for operating a 3GPP mobile communications system including a core network and a user equipment (UE), wherein the UE is configured to communicate with the core network via a satellite communication link, is provided. The method comprising: identifying one or more discontinuous coverage parameters of the satellite communication link with the UE; and determining one or more communication parameters of the UE for communicating via the satellite communication link based on the discontinuous coverage parameters.

In an embodiment, the one or more discontinuous coverage parameters of the satellite communication link includes a satellite fly-over time and a remaining time before the satellite flyover a time commences.

In an embodiment, the one or more communication parameters of the UE includes an active time value for a Mobile Initiated Connection Only (MICO) or Power Savings Mode (PSM) mode; an estimated maximum wait time; and a time for the UE to be in a connected mode.

In an embodiment, determining an active time value for a Mobile Initiated Connection Only (MICO) or Power Savings Mode (PSM) mode includes determining the active time value to be less than or equal to the satellite flyover time, and positioning the active time within the satellite flyover time.

In an embodiment, determining an estimated maximum wait time includes determining the estimated maximum wait time based on an expected time until a next satellite flyover commences.

In an embodiment, determining a time for the UE to be in a connected mode includes one or more of: determining the time for the UE to be in a connected mode based on a satellite flyover time or a remaining satellite flyover time; determining the time for the UE to be in a connected mode based on a subscription parameter of the UE; determining the time for the UE to be in a connected mode based on a request received from the UE; determining the time for the UE to be in a connected mode based a volume of data to be transmitted or received by the UE; and determining the time for the UE to be in a connected mode based on a battery level of the UE.

In an embodiment, a 3GPP mobile communications system configured to implement the method of any preceding above.

In an embodiment, a computer readable storage medium having stored thereon computer executable instructions which when executed by a 3GPP mobile communications system cause the 3GPP mobile communications system to perform the method of any of preceding above.

1. A method performed by an access and mobility management function (AMF) in a satellite communication with discontinuous coverage, the method comprising:
identifying one or more parameters associated with discontinuous coverage;
determining, based on the one or more parameters associated with discontinuous coverage, a user equipment (UE) out-of-coverage period; and
in case of determining the UE-out-of-coverage period, transmitting to the UE a signal including an extended connected time parameter, wherein the UE is maintained in a connected mode for the extended connected time parameter.

2. The method of claim 1, wherein the UE-out-of-coverage period comprises a period in which there is a lack of availability of satellite coverage for the UE.

3. The method of claim 1, wherein the one or more parameters associated with discontinuous coverage includes at least one of: a satellite fly-over time or a remaining time before the satellite flyover a time commences.

4. The method of claim 1, further comprising:
providing the extended connected time parameter to a Radio Access Network (RAN) via higher layer signalling.

5. The method of claim 1, wherein the UE is maintained in an N2 connection for the extended connected time parameter.

6. A method performed by a user equipment (UE) in a satellite communication with discontinuous coverage, the method comprising:
in case of determining an UE-out-of-coverage period, receiving, from an access and mobility management function (AMF), a signal including an extended connected time parameter,
wherein one or more parameters associated with discontinuous coverage are identified, and
wherein based on the one or more parameters associated with discontinuous coverage, the UE-out-of-coverage period is determined; and
maintaining in connected mode for the extended connected time parameter.

7. The method of claim 6, wherein the UE-out-of-coverage period comprises a period in which there is a lack of availability of satellite coverage for the UE.

8. The method of claim 6, wherein the one or more parameters associated with discontinuous coverage includes at least one of: a satellite fly-over time or a remaining time before the satellite flyover a time commences.

9. The method of claim 6, wherein the receiving the signal including the extended connected time parameter comprises receiving the signal from a Radio Access Network (RAN) via higher layer signalling.

10. The method of claim 6, wherein maintaining in connected mode comprises maintaining an N2 connection.

11. An access and mobility management function (AMF) in a satellite communication with discontinuous coverage, the AMF comprising:
a transceiver; and
at least one processor coupled with the transceiver and configured to:
identify one or more parameters associated with discontinuous coverage;
determine, based on the one or more parameters associated with discontinuous coverage, a user equipment (UE) out-of-coverage period; and
in case of determining the UE-out-of-coverage period, transmit to the UE a signal including an extended connected time parameter, wherein the UE is maintained in a connected mode for the extended connected time parameter.

12. The AMF of claim 11, wherein the UE-out-of-coverage period comprises a period in which there is a lack of availability of satellite coverage for the UE.

13. The AMF of claim 11, wherein one or more parameters associated with discontinuous coverage includes at least one of: a satellite fly-over time or a remaining time before the satellite flyover a time commences.

14. The AMF of claim 11, the at least one processor further configured to: provide the extended connected time parameter to a Radio Access Network (RAN) via high layer signalling.

15. A user equipment (UE) in a satellite communication with discontinuous coverage, the UE comprising:
a transceiver; and
at least one processor coupled with the transceiver and configured to:
in case of determining an UE-out-of-coverage period, receive, from an access and mobility management function (AMF), a signal including an extended connected time parameter,
wherein one or more parameters associated with discontinuous coverage are identified, and
wherein based on the one or more parameters associated with discontinuous coverage, the UE-out-of-coverage period is determined; and
maintain in connected mode for the extended connected time parameter.
